(19) United States
(12) Patent Application Publication
(10) Pub. No.: US 2006/0225987 A1
(43) Pub. Date: Oct. 12, 2006

(54) BILL CABINET

(75) Inventors: Tien-Yuan Chien, TAIPEI (TW); Cheng-Kang Yu, TAIPEI (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City (TW)

(21) Appl. No.: 10/907,563

(22) Filed: Apr. 6, 2005

(51) Int. Cl. G07F 9/10

(52) U.S. Cl. 194/350

(57) ABSTRACT

A bill cabinet used in an automatic vending machine for collecting bills is disclosed to include a bill receiver for receiving inserted bills and a cabinet body for collecting received bills, the cabinet body having a receiving open chamber, a bill entrance, a bearing board suspending in the receiving open chamber and movable forwards/backwards between the bill entrance and the bottom side of the receiving open chamber far from the bill entrance, spring members supporting the bearing board in the receiving open chamber, and two elastically deformable spring strips symmetrically and detachably provided at two sides in the bill entrance and defining a gate for allowing movement of the pressure board in and out of the bill entrance to carry the received bill to the bearing board and to let the received bill be further stopped between the bearing board and the spring strips after return of the pressure board to the bill receiver through the bill entrance.

### BACKGROUND OF THE INVENTION

1. Field of the Invention

The present invention relates to a bill cabinet for use in an automatic vending machine to receive bills more particularly, to such a bill cabinet that uses detachable spring strips to control the bill entrance such that the user can conveniently replace the spring strips to fit different bills.

2. Description of the Related Art

Following fast development of technology, our mode of living has been changed. Various automatic vending machines (card dispensers, ticket vending machines, coin-exchange machines, etc.) are used everywhere to sell any of a variety of products without the service of a serviceman.

Further, every country issues different bills (banknotes) of different values. Regular bill cabinets for use in automatic vending machines are designed to fit bills of one particular width. For receiving bills of different values, different bill cabinets shall be used. The fabrication of different bill cabinets requires different molds, resulting in a high manufacturing cost.

### SUMMARY OF THE INVENTION

The present invention has been accomplished under the circumstances in view. It is one object of the present invention to provide a bill cabinet for use with a bill receiver in an automatic vending machine for collecting bills, which facilitates movement of the pressure board of the bill receiver in and out of the bill entrance of the cabinet body upon a bill receiving cycle. It is another object of the present invention to provide a bill cabinet for use with a bill receiver in an automatic vending machine for collecting bills, which prevents sticking of the received bill in the bill entrance. To achieve these and other objects of the present invention, the bill cabinet comprises a cabinet body and a bill receiver fastened to the cabinet body and used with the cabinet body in an automatic vending machine for collecting bills. The cabinet body comprises a receiving open chamber, a bill entrance, a bearing board suspending in the receiving open chamber and movable forwards/backwards between the bill entrance and the bottom side of the receiving open chamber far from the bill entrance, and spring members supporting the bearing board in the receiving open chamber. The bill receiver comprises a pressure board movable in and out of the bill entrance and adapted to carry inserted bills to the pressure board. The cabinet body further comprises two elastically deformable spring strips symmetrically and detachably provided at two sides in the bill entrance and defining a gate for allowing movement of the pressure board in and out of the bill entrance to carry the received bill to the bearing board and to let the received bill be further stopped between the bearing board and the spring strips after return of the pressure board to the bill receiver through the bill entrance.

### BRIEF DESCRIPTION OF THE DRAWINGS

FIG. 1 is an elevational view of a cabinet body according to the present invention.

FIG. 2 is an exploded view of the cabinet body according to the present invention.

FIG. 3 is an elevational view of a bill receiver according to the present invention.

FIG. 3A is an elevational view of a bill pressure board according to the present invention.

FIG. 4 in an elevational view showing the cabinet body fastened to the bill receiver according to the present invention.

FIG. 5 is a side view in section in an enlarged scale of the assembly of FIG. 4.

FIG. 6 corresponds to FIG. 5, showing a stack of bills pushed into the inside of the cabinet body according to the present invention.

FIG. 7 is a top view of the assembly of FIG. 4.

FIG. 8 is a top view of an alternate form of the present invention.

### DETAILED DESCRIPTION OF THE PREFERRED EMBODIMENT

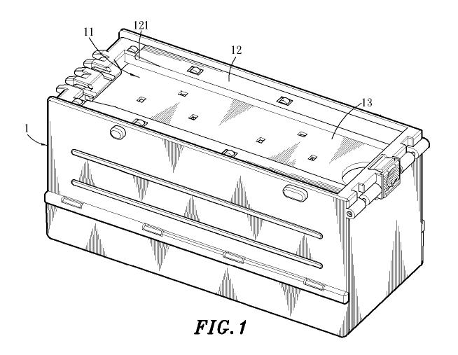

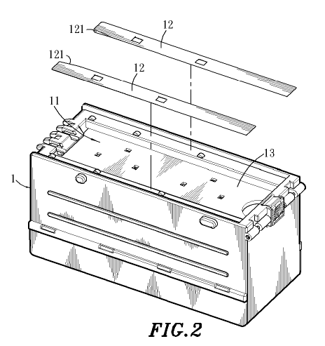

Referring to FIGS. 1-4 and 6, a bill cabinet in accordance with the present invention is shown comprising a cabinet body 1 defining therein a receiving open chamber 10 and a bill entrance 11 at the front side thereof in communication between the receiving open chamber 10 and the outside space. Two longitudinal spring strips 12 are symmetrically detachably provided at the bill entrance 11 at two sides and spaced from each other at a pitch subject to the width of the bills (banknotes) 3 to be received, each having a beveled guide portion 121 at one side. Because the spring strips 12 are detachably installed in the cabinet body 1, the user can selectively use different sizes of spring strips 12 subject to the width of the bills to be received. A bearing board 13 is provided inside the receiving open chamber 10 and supported on spring members 14 for collecting received bills 3. According to this embodiment, the spring members 14 are conical springs that holds the bearing board 13 at the bottom side of the spring strips 12, allowing forwards/backwards movement the bearing board 13 between the top side (bill entrance 11) and the bottom side within the receiving open chamber 10.

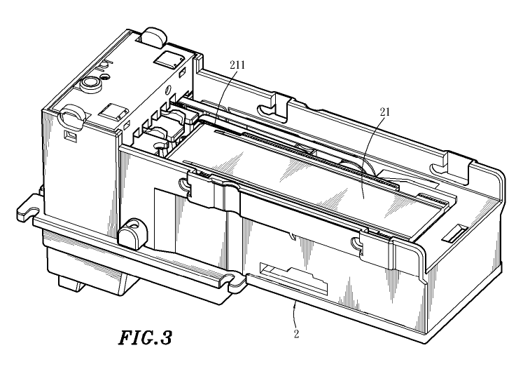

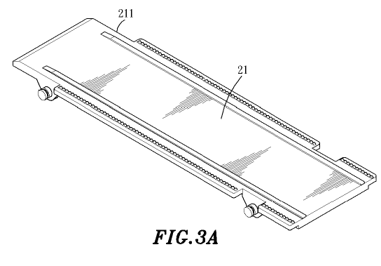

The cabinet body 1 is used with a bill receiver 2 (see FIG. 3). The bill receiver 2 comprises a pressure board 21 movable between the top and bottom sides thereof. The pressure board 21 has a reduced front extension 211 (see FIG. 3A). The reduced front extension 211 has a width shorter than the width of the pressure board 21.

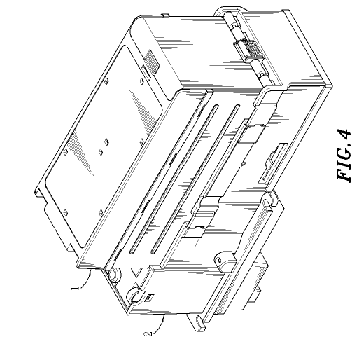

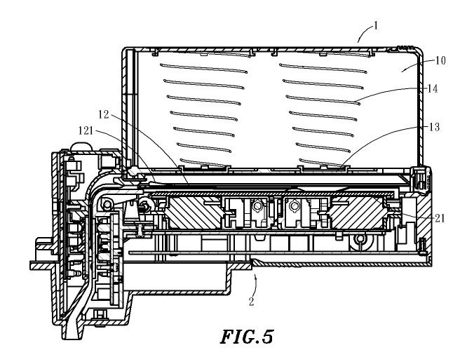

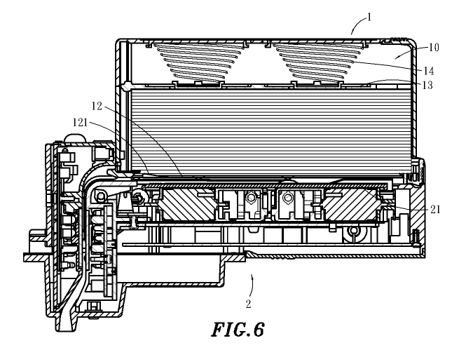

Referring to FIGS. 5 and 7 and FIGS. 4 and 6 again, the cabinet body 1 is fastened to the top side of the bill receiver 2. When a bill 3 is inserted into the bill slot of the automatic vending machine and delivered to the gap between the pressure board 21 of the bill receiver 2 and the bearing board 13 of the cabinet body 1, a sensor (not shown) in the bill receiver 2 immediately detects the presence of the bill 3 in the gap between the pressure board 21 of the bill receiver 2 and the bearing board 13 of the cabinet body 1. Upon detection of the presence of the bill 3 in the gap between the pressure board 21 of the bill receiver 2 and the bearing board 13 of the cabinet body 1, the sensor immediately drives the driving mechanism (not shown) of the bill receiver 2 to move the pressure board 21 toward the inside of the cabinet body 1 and to further force the bill 3 against the bearing board 13. When moving the pressure board 21 toward the inside of the cabinet body 1, the pressure board 21 forces the spring strips 12 to deform elastically, and at the same time the reduced front extension 211 of the pressure board 21 forces the bill 3 to move over the beveled guide portions 121 of the spring springs 12 to the inside of the receiving open chamber 10 of the cabinet body 1, reducing friction between the pressure board 21 and the spring strips 12. When entered the cabinet body 1, the pressure board 21 pushes the bill 3 and the bearing board 13 against the conical springs 14, causing the conical springs 14 to be compressed. After the bearing board 13 has been set into position, the pressure board 21 is returned. During return stroke of the pressure board 21, the beveled guide portions 121 of the spring strips 12 guide the reduced front extension 211 to move over the spring strips 12 in the revered direction, and therefore the pressure board 21 is smoothly moved out of the receiving open chamber 10 of the cabinet body 1 and returned to the bill receiver 2, and the conical springs 14 return to their former shape to support the bearing board 13 and the bill 3 against the bottom side of the spring strips 12 in the bill entrance 11 (see FIG. 6). This design prevents jammed of the received bill 3 in the bill entrance 11 around the front end of each spring strip 12. By means of the design of the beveled guide portions 121 of the spring strips 12 and the reduced front extension 211 of the pressure board 21, less friction is produced when moving the pressure board 21 in or out of the bill entrance 11, preventing disconnection of the spring strips 12 from the cabinet body 1 or falling of the received bill 3 from the bearing board 13 due to an excessively high friction force between the pressure board 21 and the spring strips 12, i.e., the spring strips 12 is smoothly elastically deformable for allowing smooth movement of the pressure board 21 in and out of the bill entrance 11 during collection of a bill 3.

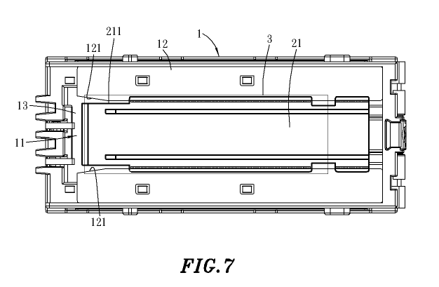

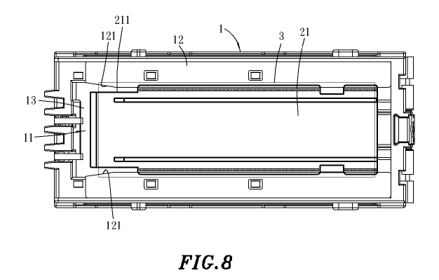

Referring to FIG. 8 and FIG. 7 again, different sizes of spring strips 12 may be selectively used in the cabinet body 1 subject to the type (width) of the bills 3 to be received. For example, the spring strips 12 used in FIG. 7 define there between a gate relatively wider for receiving first bills, the spring strips 12 used in FIG. 8 define there between a gate relatively narrower for receiving second bills.

As indicated above, the invention provides a bill cabinet comprising a cabinet body and a bill receiver and used in an automatic vending machine for collecting bills, which can be adjusted to fit different bills (banknotes) simply by changing the detachable spring strips at the bill entrance of the cabinet body. Further, the spring strips each have a beveled guide portion at the front side, and the pressure board has a reduced front extension corresponding to the beveled guide portions of the spring strips for easy movement of the pressure board of the bill receiver in and out of the cabinet body through the bill entrance to prevent sticking of the received bill in the bill entrance.

A prototype of bill cabinet has been constructed with the features of FIGS. 1-8. The bill cabinet functions smoothly to provide all of the features discussed earlier.

Although particular embodiments of the invention have been described in detail for purposes of illustration, various modifications and enhancements may be made without departing from the spirit and scope of the invention, for example, one single spring strip may be used and provided at one lateral side of the bill entrance instead of the use of two spring strips in the aforesaid embodiments. Accordingly, the invention is not to be limited except as by the appended claims.

What is claimed is:

1. A bill cabinet comprising a cabinet body and a bill receiver fastened to said cabinet body and used with said cabinet body in an automatic vending machine for collecting bills, said cabinet body comprising a receiving open chamber, a bill entrance, a bearing board suspending in said receiving open chamber and movable forwards/backwards between said bill entrance and a bottom side of said receiving open chamber far from said bill entrance, and spring members supporting said bearing board in said receiving open chamber, said bill receiver comprising a pressure board movable in and out of said bill entrance and adapted to carry inserted bills to said pressure board, wherein said cabinet body comprises at least one elastically deformable spring strip each detachably mounted in said bill entrance and defining with said bill entrance a gate for allowing movement of said pressure board in and out of said bill entrance to carry a received bill to said bearing board and to let the received bill be further stopped between said bearing board and said at least one spring strip after return of said pressure board to said bill receiver through said bill entrance.

2. The bill cabinet as claimed in claim 1, wherein said at least one spring strip each has a beveled front guide portion for guiding entrance of the received bill and said pressure board into said bill entrance and said receiving open chamber.

3. The bill cabinet as claimed in claim 1, wherein the number of said at least one spring strip is 2, and the two spring strips are detachably fastened to said cabinet body at two sides of said bill entrance.

4. The bill cabinet as claimed in claim 1, wherein said pressure board has a reduced front extension, said reduced front extension having a width smaller than the width of the gate defining in said bill entrance by said at least one spring strip.
